(19) United States
(12) Patent Application Publication
(10) Pub. No.: US 2020/0199921 A1
(43) Pub. Date: Jun. 25, 2020

(54) LOCK FOR A DOUBLE PANE DOOR AND LOCKABLE REFRIGERATOR DOOR SYSTEM

(71) Applicant: EDC Energy Door Company, L'assomption (CA)

(72) Inventor: Mathieu GRENIER, Repentigny (CA)

(21) Appl. No.: 16/227,684

(22) Filed: Dec. 20, 2018

(51) Int. Cl. E05C 7/04; E05C 9/02

(52) U.S. Cl. CPC E05C 7/045; E05C 9/025; E05B 65/005; E05C 9/028; E05C 9/026

(57) ABSTRACT

The present disclosure relates to a lock for a double pane door. A lock body includes a cylinder and a bolt. A main body has front and rear faces, a bore receiving the cylinder of the lock body mounted on the rear face so that a key can be inserted in the cylinder from a front of the main body, and a pair of extensions projecting from the rear face of the main body. A bracket is mountable to a rail of the door frame at a junction between panes of the double pane door. The bracket forms a pair of recesses receiving the pair of extensions between the bracket and the rail when the main body is positioned for locking the doors. The bracket also has an opening for receiving the bolt when the bolt is placed in a locked position by action of the cylinder.

### TECHNICAL FIELD

The present disclosure relates to the field of door locking devices. More specifically, the present disclosure relates to a lock for a double pane door and to a lockable refrigerator door system.

### BACKGROUND

Large commercial refrigerators commonly have double pane doors, also called French doors, giving access to consumers to goods such as food and beverages. It may be desired to lock these doors to restrict access to some of these goods, for example when regulations prevent the sale of alcohol stored in a refrigerator after hours. Common methods for locking double pane doors are not convenient and may be unsightly. For instance, some users will mount chains to door handles and use padlocks to lock the doors.

There is a need for door locks that can be easily mounted to and dismounted to doors, such as double pane doors for refrigerator systems.

### SUMMARY

According to the present disclosure, there is provided a lock for a double pane door mounted to a door frame. The lock comprises a lock body, a main body, and a bracket. The lock body includes a cylinder operatively connected to a bolt. The main body has a front face and an opposite rear face. The main body also has a bore adapted for receiving the cylinder of the lock body mounted on the rear face of the main body so that a key can be inserted in the cylinder from a front of the main body. The main body further has a pair of extensions projecting from the rear face of the main body. The bracket is adapted to be mounted to a rail of the door frame at a junction between panes of the double pane door. The bracket forms a pair of recesses configured for receiving the pair of extensions between the bracket and the rail of the door frame when the main body is positioned for locking the door. The bracket further has an opening adapted for receiving the bolt when the bolt is placed in a locked position by action of the cylinder.

The present disclosure also relates to a lock, comprising a cylinder operatively connected to a bolt, a main body having a bore adapted for receiving the cylinder so that the cylinder can be actuated from a front of the main body, the main body further having a pair of extensions projecting from a rear of the main body, and a bracket adapted to be mounted to a frame, the bracket forming a pair of recesses configured for receiving the pair of extensions between the bracket and the frame, the bracket further having an opening adapted for receiving the bolt when the bolt is placed in a locking position by action of the cylinder.

According to the present disclosure, there is also provided a lockable refrigerator door system. The lockable refrigerator door system comprises a door frame and a double pane door. The door frame comprises four frame sections assembled to form a rectangular opening. The four frame sections comprise left and right vertical rails, an upper horizontal rail and a lower horizontal rail. One pane has hinges mounted to the left vertical rail, and an other pane has hinges mounted to the right vertical rail. The refrigerator door system also comprises the lock for double pane door, in which the bracket is mounted to one of the upper and lower horizontal rails, substantially at a junction between panes of the double pane door.

The present disclosure further relates to a lockable refrigerator door system. The lockable refrigerator door system comprises a door frame and a plurality of double pane doors. The door frame comprises an upper horizontal rail, a lower horizontal rail, and a plurality of vertical rails connecting the upper and lower horizontal rails so that a rectangular opening is formed between each pair of adjacent vertical rails. Each of double pane door is mounted in a corresponding rectangular opening so that one pane has hinges mounted to a vertical rail on a left side of the corresponding rectangular opening and an other pane has hinges mounted to a vertical rail on a right side of the corresponding rectangular opening. The lock for double pane door is mounted to one of the upper and lower horizontal rails, in each of the plurality of rectangular openings, substantially at a junction between panes of the double pane door mounted in that rectangular opening.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is an exploded perspective view of a lock for a double pane door according to an embodiment;

FIG. 2 is a side elevation view of the lock of FIG. 1;

FIG. 3 is a perspective view of the lock of FIG. 1;

FIG. 4 is a front elevation view of the lock of FIG. 1;

FIG. 5 is a cutaway view of the lock of FIG. 1;

FIG. 6 is a top plan view of the lock of FIG. 1;

FIG. 7 is a perspective view of a main body of the lock of FIG. 1;

FIG. 8 is a rear elevation view of the main body of FIG. 7;

FIG. 9 is a top plan view of the main body of FIG. 7;

FIG. 10 is a bottom perspective view of a bracket of the lock of FIG. 1;

FIG. 11 is a front elevation view of the bracket of FIG. 10;

FIG. 12 is a top plan view of the bracket of FIG. 10;

FIG. 13 is a perspective view showing an alignment of the main body and of the bracket;

FIG. 14 is a perspective view showing a connection between the main body and the bracket;

FIG. 15 is a perspective view of a double pane door showing alternative placements of the lock of FIG. 1;

FIG. 16 is a detailed perspective view of the double pane door on which the bracket is mounted, further showing an alignment of the main body;

FIG. 17 is a detailed perspective view of the double pane door with the lock installed;

FIG. 18 is a front elevation view of a refrigerator door system on which the lock is installed;

FIG. 19 is a detailed view of the lock installed on the refrigerator door system of FIG. 18;

FIG. 20 is a cross-sectional view of the refrigerator door system of FIG. 18;

FIG. 21 is a detailed cross-sectional view of the lock on the refrigerator door system;

FIG. 22 is a rear elevation view of the lock body of the lock of FIG. 1.

Like numerals represent like features on the various drawings. Some of the drawings may not be to scale.

### DETAILED DESCRIPTION

Various aspects of the present disclosure generally address one or more of the problems of easily mounted and dismounting locks from doors, including without limitation on refrigerator door systems.

In an aspect, the present disclosure introduces a door lock that includes a bracket that may be fixedly mounted to an upper or lower rail of a door frame, substantially at a junction between panes of a double pane door, or French door, and a dismountable lock body attached to a main body. The bracket is sized and configured to freely allow opening and closing of the door. The main body has extensions that project so that they reach within recesses formed between the bracket and the rail when the main body is in place for locking the double pane door. The lock body has a cylinder actuated bolt that, when actuated, is inserted in an opening of the bracket. The combination and configuration of the bolt, the extensions and the bracket are such that the main body is held fixedly in place when the lock is locked, preventing opening of the double pane door.

In the present disclosure, the expressions “a double pane door” and “a French door” are used in the singular form to refer to a door having a pair of matching door panes, the door panes having proximally located handles and opposite hinges.

The lock can be mounted on a rail of a door frame, for example on a lower rail or on an upper rail of the door frame. In the following description, most examples are described in the non-limiting context where the lock is mounted to the lower rail of the door frame. As such, when the present disclosure uses terms such as “elevated”, “lowered”, and “flattened-M”, these terms are meant to refer to placement of the lock on the lower rail of the door frame. None of these terms and description of features is intended to limit the present disclosure to other placements of the lock on any part of a door frame.

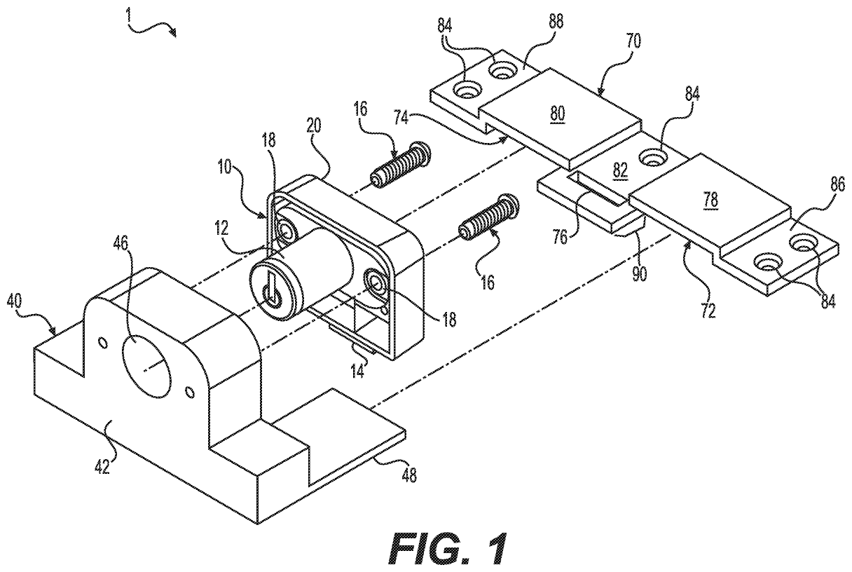

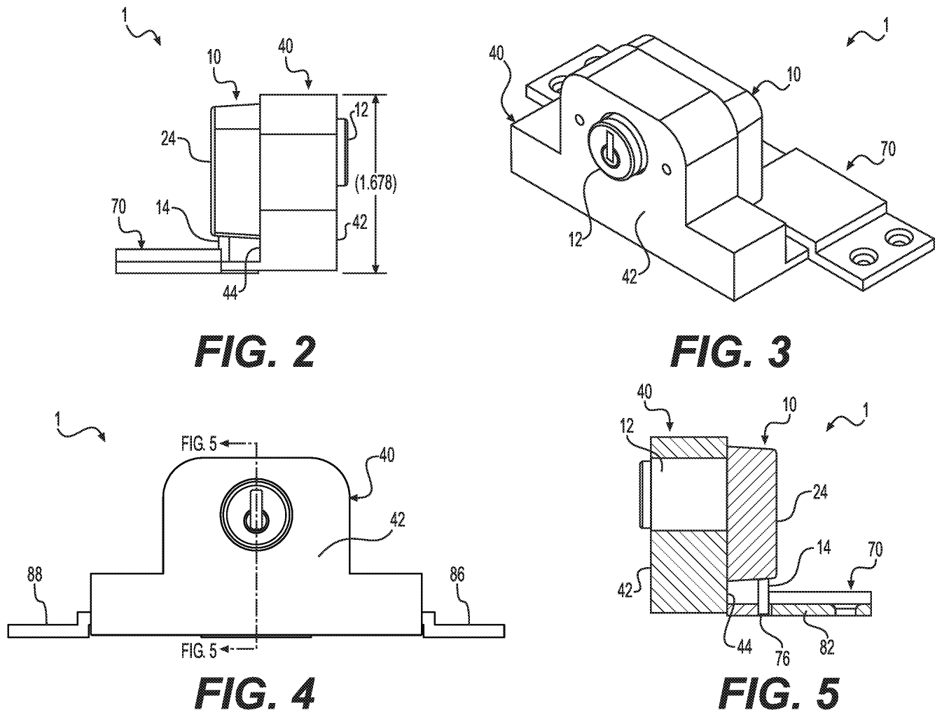

Referring now to the drawings, FIG. 1 is an exploded perspective view of a lock for a double pane door according to an embodiment. FIG. 2 is a side elevation view of the lock of FIG. 1. FIG. 3 is a perspective view of the lock of FIG. 1. FIG. 4 is a front elevation view of the lock of FIG. 1. FIG. 5 is a cutaway view of the lock of FIG. 1. Referring to FIGS. 1-5, a lock 1 comprises a lock body 10, a main body 40, and a bracket 70. The lock body 10 includes a cylinder 12 operatively connected to a bolt 14. The main body 40 has a front face 42 and an opposite rear face 44. The main body 40 also has a bore 46 adapted for receiving the cylinder 12 of the lock body 10 when the lock body 10 is attached to the rear face 44 of the main body 40. A pair of screws 16 for mounting the lock body 10 to the main body 40 is also included. The lock body 10 has a pair of through apertures 18 adapted for insertion of the screws 16. The main body 40 has a pair of apertures 52 matching the apertures 18 of the lock body 10 and adapted for receiving extremities of the screws 16. The lock body 10 remains attached to the main body 40 in normal operation, including when the lock 1 is removed from the double pane door. Other manner of attaching the lock body 10 to the main body 40, including for example gluing or welding, are also contemplated. In an embodiment, the lock body 10 and the main body 40 may be constructed as a unitary piece. In the same or another embodiment, other means for actuating the cylinder 12 mounted to the front of the main body 40 may include, for example, a combination locking device.

Respective shapes of the lock body 10 and of the main body 40 are such that a key (not shown) can be inserted in the cylinder 12 from a front of the main body 40. In a non-limiting embodiment, the lock body 10 may be an off-the shelf part primarily made of metal parts. Generally speaking the main body 40 is shaped to match the shape of the lock body 10. Use of a differently shaped lock body along with another main body shaped to match that lock body is also contemplated.

The main body 40 has a pair of extensions 48, 50 projecting from the rear face 44 of the main body 46. The extensions 48, 50 are adapted for matching with the bracket 70 that, in turn, is adapted to be mounted to a rail of the door frame at a junction between panes of the double pane door (door systems are shown on later Figures). The bracket 70 forms a pair of recesses 72, 74 configured for receiving the pair of extensions 48, 50 between the bracket 70 and the rail of the door frame when the main body 40 is positioned for locking the door. The bracket 70 also has an opening 76 adapted for receiving the bolt 14 when the bolt 14 is placed in a locking position by action of the cylinder 12.

In an embodiment, the main body 40 and the bracket 70 are made of aluminum, for example in a 1060 alloy. Use of other materials, for example stainless steel or brass, is also contemplated.

FIG. 22 is a rear elevation view of the lock body of the lock of FIG. 1. The lock 1 may further comprise a cover 20 for the lock body 10. The cover 20 covers a top side, lateral sides, and a rear face of the lock body 10. A rear face 24 of the cover 20 is adapted to be placed in contact with edges of panes of the double pane door when the lock 1 is in a locked position on the door frame. In a non-limiting embodiment, the cover 20 may be made of plastic.

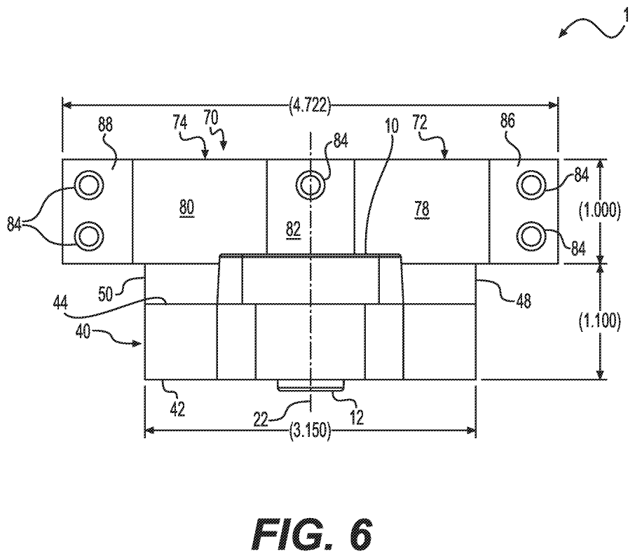

FIG. 6 is a top plan view of the lock of FIG. 1. In an embodiment, each of the main 40 body and the bracket 70 is symmetrical about a central axis 22 defined by the cylinder 12, so that one of the pair of extensions 48, 50 and one of the pair of recesses 72, 74 are on each side of the cylinder 12.

It may be noted that the dimensions shown on FIGS. 2 and 6 are in inches and are provided for illustration purposes without limiting the generality of the present disclosure.

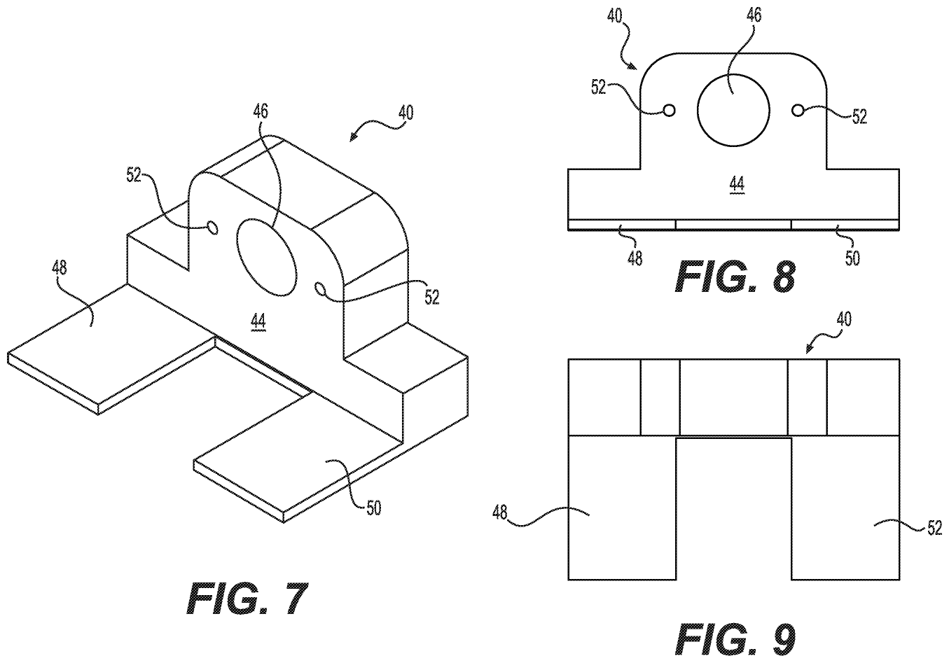

Example details of a construction of the main body 40 are provided on FIG. 7, which is a perspective view of a main body of the lock of FIG. 1, FIG. 8, which is a rear elevation view of the main body of FIG. 7, and FIG. 9, which is a top plan view of the main body of FIG. 7.

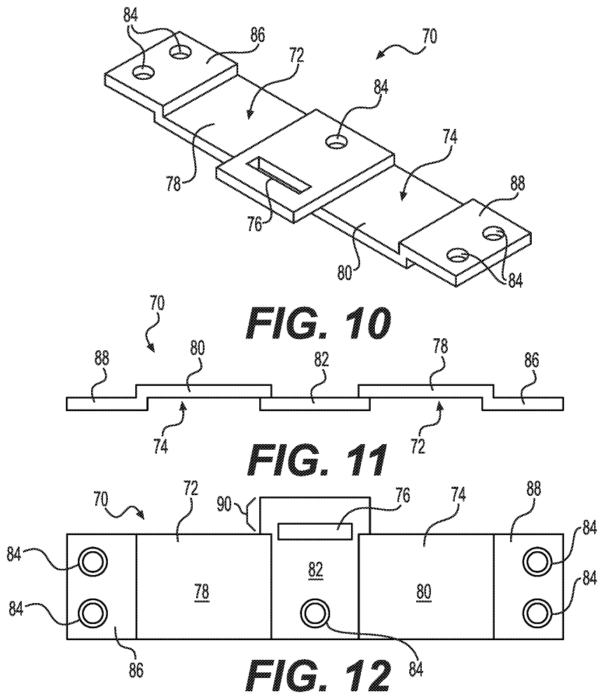

FIG. 10 is a bottom perspective view of a bracket of the lock of FIG. 1. FIG. 11 is a front elevation view of the bracket of FIG. 10. FIG. 12 is a top plan view of the bracket of FIG. 10. As best seen on FIG. 11, the bracket 70 has a flattened-M cross-section, the recesses 72, 74 being formed between elevated sections 78, 80 of the bracket 70 and the rail of the door frame to which the bracket 70 may be mounted. The opening 76 adapted for receiving the bolt 14 is formed in a central lowered section 82 of the bracket 70. In more details, the opening 76 is in a forward projecting section 90 of the bracket 70. Apertures 84 are formed in the central lowered section and 82 in additional lowered sections 86, 88 at opposite ends of the bracket 70, the apertures 84 being adapted for receiving fasteners (not shown) for mounting the bracket 70 to the rail of the door frame. Different numbers and positions of the apertures on the lowered sections 82, 86 and 88 may be contemplated.

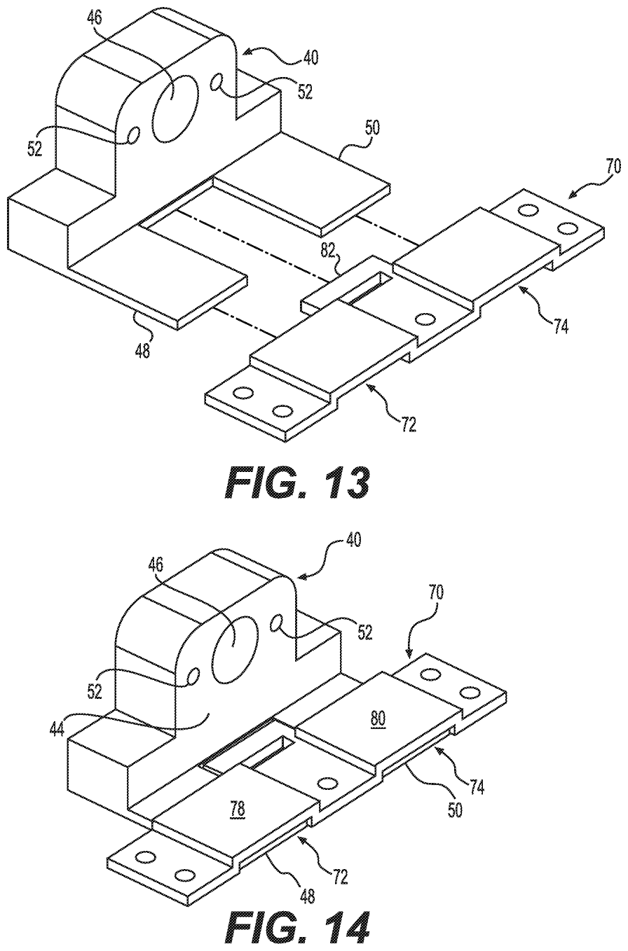

FIG. 13 is a perspective view showing an alignment of the main body and of the bracket. FIG. 14 is a perspective view showing a connection between the main body and the bracket. The lock body 10 is omitted from the views of FIGS. 13 and 14 to better illustrate the interaction of the main body 40 with the bracket 70, particularly the interaction of the extensions 48, 50 and of the recesses 72, 74. In the illustrated example, a length of the extensions 48, 50 is such that they fully extend underneath the elevated sections 78, 80 when a forward end of the central lowered section 82 abuts on the rear face 44 of the main body 40, between the extensions 48, 50. Other configurations may be contemplated.

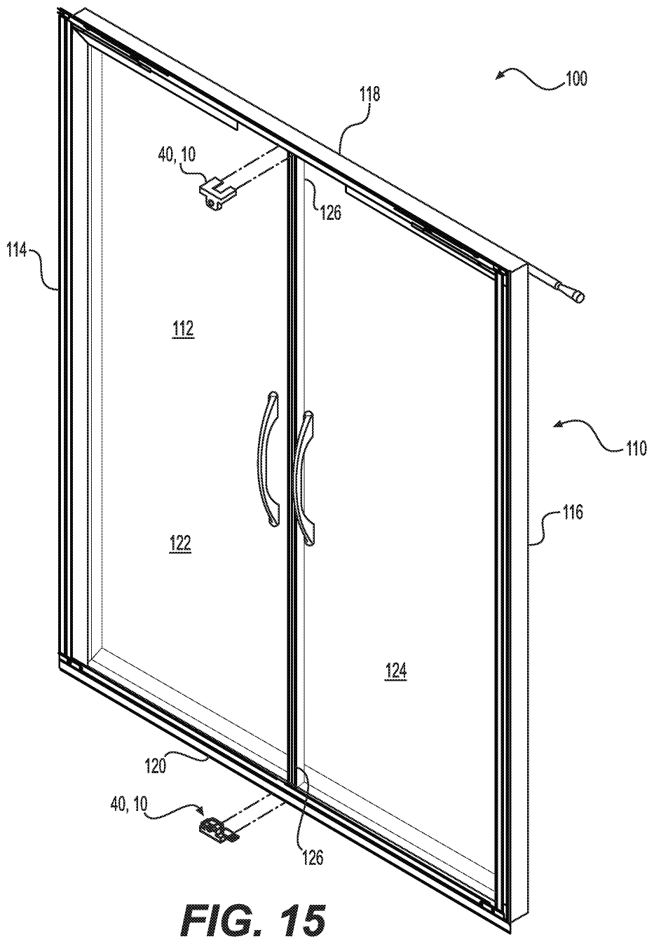

FIG. 15 is a perspective view of a double pane door showing alternative placements of the lock of FIG. 1. A lockable refrigerator door system 100 comprises four (4) frame sections assembled to form a rectangular opening 112. The four frame sections comprise a left vertical rail 114, a right vertical rail 116, an upper horizontal rail 118 and a lower horizontal rail 120. The refrigerator door system 100 also comprises a double pane door, one pane 122 having hinges (not shown) mounted to the left vertical rail 114, another pane having 124 hinges (not shown) mounted to the right vertical rail 116. The lock 1 is mounted to the refrigerator door system 100. In more details, the bracket 70 is mounted to either one of the upper horizontal rail 118 and lower horizontal rail 120 (the bracket 70 is visible on the lower horizontal rail 120), substantially at a lower or upper junction 126 between the panes 122, 124 of the double pane door. As shown, the lock 1 may be mounted at an upper or lower end of the refrigerator door system 100 by mounting the bracket 70 on the lower horizontal rail 120 or on the upper horizontal rail 118 and by then attaching the combination formed of the main body 40 and the lock body 10 to the bracket 70.

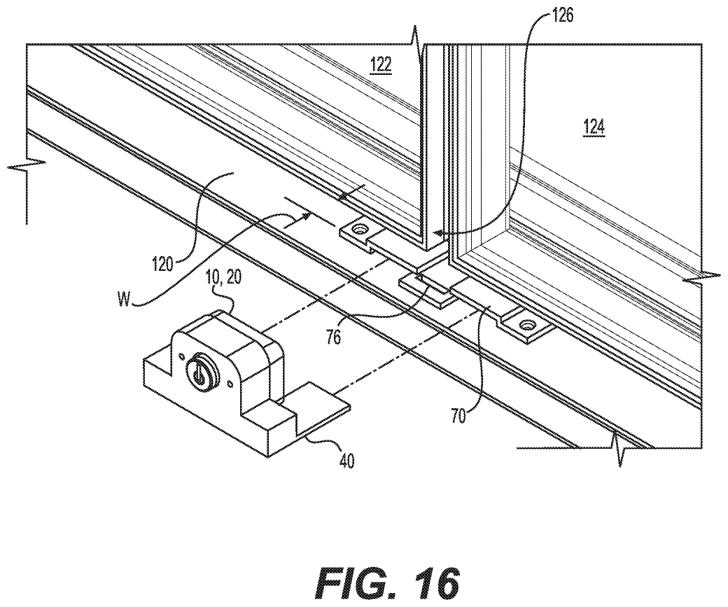

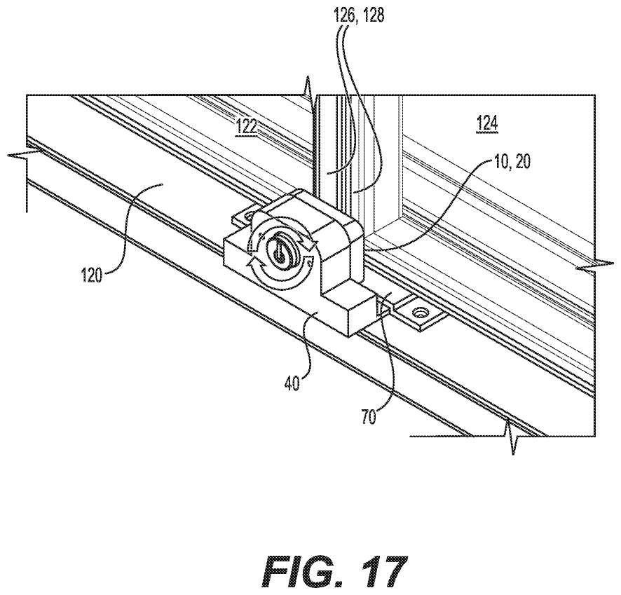

FIG. 16 is a detailed perspective view of the double pane door on which the bracket is mounted, further showing an alignment of the main body. FIG. 17 is a detailed perspective view of the double pane door with the lock installed. Arrows shown around the cylinder 12 illustrate how the lock 1 may be locked or unlocked by action of a key to move the bolt 14 in and out of the opening 76 of the bracket 70. A thickness of the bracket 70 is configured to allow opening of the door when the lock body 10 and the main body 40 are removed from the door frame. When the panes 122, 124 are closed, the bracket 70 should protrude in front of edges 128 of the panes 122, 124 by a sufficient margin ‘w’ to allow placement of the main body 40 and of the lock body 10 so that the bolt 14 can be inserted in the opening 76 while leaving a minimal gap between the edges 128 of the panes 122, 124 and the rear face 24 of the cover 20 of the lock body 10. In this manner, movements of the panes 122, 124 will be limited when the lock 1 is mounted in a locked position on the door frame 110. Considering FIG. 17 and the structure of the lock 1 as shown on earlier Figures, pulling the lock 1 away from the double pane door by applying a force along the axis of the cylinder 12 is prevented by the placement of the bolt 14 within the opening 76 of the bracket 70. Pulling the lock 1 upward or in a rotating motion is prevented by the placement of the extensions 48, 50 within the recesses 72, 74 formed between the bracket 70 and the rail 120.

In an embodiment, two (2) locks 1 may be respectively mounted to the upper and lower horizontal rails 118, 120 of the refrigerator door system 100.

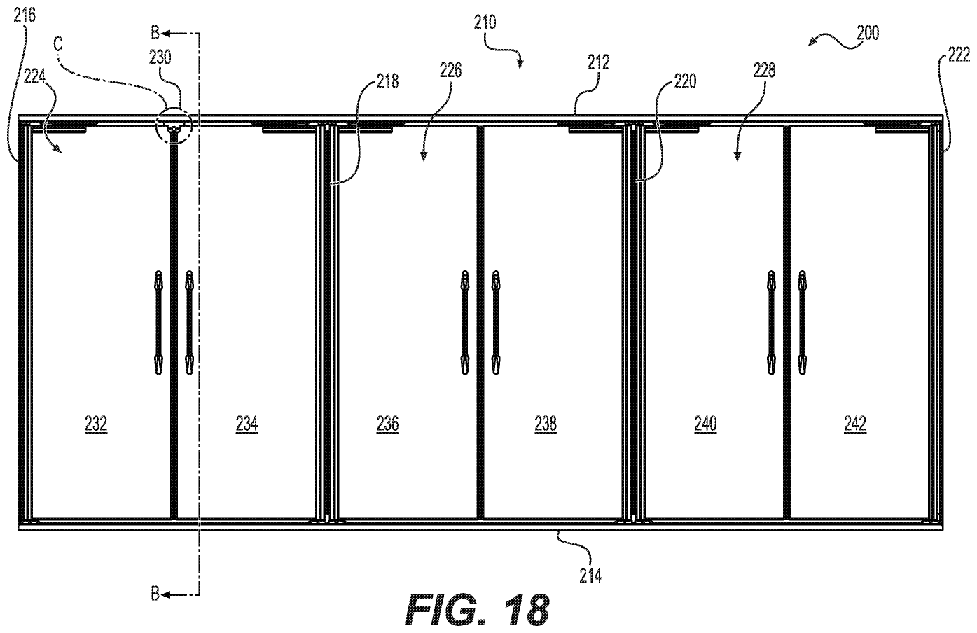

FIG. 18 is a front elevation view of a refrigerator door system on which the lock is installed. A lockable refrigerator door system 200 comprises a door frame 210 having an upper horizontal rail 212, a lower horizontal rail 214, and vertical rails 216, 218, 220 and 222 that connect the upper and lower horizontal rails 212, 214 so that rectangular openings 224, 226, 228 are formed between various pairs of adjacent vertical rails 216, 218, 220, 222. It may be noted that, as illustrated, the vertical rails 218 and 220 are each constructed of a pair of joined rails. A width of the various vertical rails 216, 218, 220 and 222 is not relevant to the present disclosure so the vertical rails 218 and 220 may each be construed as a single vertical rail. Also, relative dimensions of the lock 1 and of the door frame 210 may vary greatly so the perceived dimensions shown on FIG. 18 do not limit the present disclosure.

Double pane doors are mounted in corresponding rectangular opening 224, 226, 228. In more details, panes 232 and 234 are mounted in the rectangular opening 224, between the vertical rails 216 and 218, panes 236 and 238 are mounted in the rectangular opening 226, between the vertical rails 218 and 220, and panes 240 and 232 are mounted in the rectangular opening 228, between the vertical rails 220 and 222. The various panes 232, 234, 236, 238, 240, 242 are mounted are so that one pane of a pair has hinges (not shown) mounted to a vertical rail on a left side of the corresponding rectangular opening 224, 226, 228 and another pane has hinges mounted to a vertical rail on a right side of the corresponding rectangular opening 224, 226, 228.

The lock 1 may be mounted to one of the upper and lower horizontal rails 212, 214, in each of the plurality of rectangular openings 224, 226, 228 (only one lock 1 is shown, being mounted to the upper horizontal rail 212 within the opening 224). As shown, the lock 1 is mounted substantially at a junction 230 between the panes 232, 234 of the double pane door mounted in the rectangular opening 224.

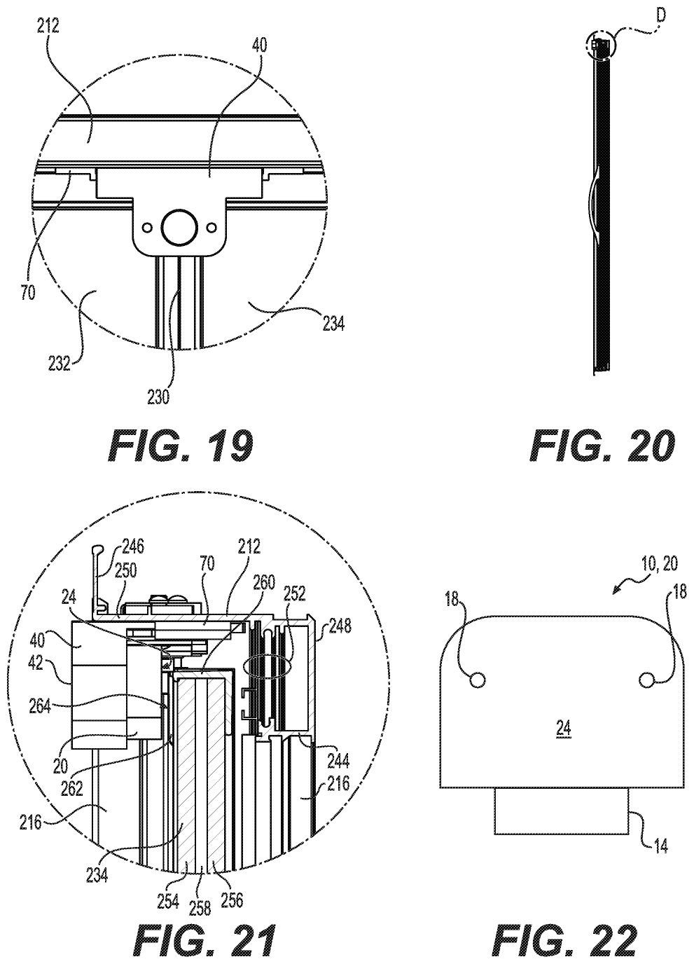

FIG. 19 is a detailed view of the lock installed on the refrigerator door system of FIG. 18. The detail of FIG. 19 is identified with the reference ‘C’ on FIG. 18. It shows how the bracket 70 is mounted to the upper horizontal rail 212 substantially centered with the junction 230 between the panes 232, 234 of the double pane door mounted in the rectangular opening 224 so that the main body 40 and lock body 10 (not visible on FIG. 19) of the lock 1 are positioned to abut on the edges of the panes 232, 234.

FIG. 20 is a cross-sectional view of the refrigerator door system of FIG. 18. The cross-sectional view of FIG. 20 is taken along a line B-B of FIG. 18. FIG. 21 is a detailed cross-sectional view of the lock on the refrigerator door system. The detail of FIG. 21 is identified with the reference D′ on FIG. 20. The upper horizontal rail 212 is connected to the vertical rail 216 at a junction 244. The upper horizontal rail 212 includes a front vertical face 246, a rear vertical face 248, a horizontal main section 250, and an insulation component 252. The pane 234 is a sealed glass unit comprising two (2) glass panels 254, 256 separated by a gap 258. The pane 234 is surrounded by sealing elements 260 and 262. As illustrated, a small gap 264 is present between the rear face 24 of the cover 20 and a front edge of the pane 234 formed by the sealing element 262. The gap 264 may not be present depending on the construction of the lock 1, of the pane 234 and of the rails 212, 216.

Although FIGS. 19, 20 and 21 provide details of the lockable refrigerator door system 200 of FIG. 18, the same or equivalent arrangement are also applicable to the lockable refrigerator door system 100 of FIG. 15. It will also be understood that the lock 1 may be used to prevent opening of a double pane door used in other applications besides refrigerator door systems. The lock 1 may for example be used to prevent opening of a double pane window. The lock 1 may be used to prevent opening of a single pane door or window. The lock 1 may be mounted to a vertical rail, or to an horizontal or vertical structure other than a rail.

Those of ordinary skill in the art will realize that the description of the lock for a double pane door and of the lockable refrigerator door system are illustrative only and are not intended to be in any way limiting. Other embodiments will readily suggest themselves to such persons with ordinary skill in the art having the benefit of the present disclosure. Furthermore, the disclosed lock and lockable refrigerator door system may be customized to offer valuable solutions to existing needs and problems related to mounting and dismounting door locks from double pane doors such as those used in refrigerator systems. In the interest of clarity, not all of the routine features of the implementations of the lock and lockable refrigerator door system are shown and described. In particular, combinations of features are not limited to those presented in the foregoing description as combinations of elements listed in the appended claims form an integral part of the present disclosure. It will, of course, be appreciated that in the development of any such actual implementation of the lock and lockable refrigerator door system, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of door locking devices having the benefit of the present disclosure.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

What is claimed is:

1. A lock for a double pane door mounted to a door frame, comprising:
a lock body including a cylinder operatively connected to a bolt;
a main body having a front face and an opposite rear face, the main body having a bore adapted for receiving the cylinder of the lock body mounted on the rear face of the main body so that a key can be inserted in the cylinder from a front of the main body, the main body further having a pair of extensions projecting from the rear face of the main body; and
a bracket adapted to be mounted to a rail of the door frame at a junction between panes of the double pane door, the bracket forming a pair of recesses configured for receiving the pair of extensions between the bracket and the rail of the door frame when the main body is positioned for locking the door, the bracket further having an opening adapted for receiving the bolt when the bolt is placed in a locking position by action of the cylinder.

2. The lock of claim 1, wherein the bracket has a flattened-M cross-section, the recesses being formed between elevated sections of the bracket and the rail of the door frame, the opening being formed in a central lowered section of the bracket.

3. The lock of claim 2, wherein apertures are formed in the central lowered section and in additional lowered sections at opposite ends of the bracket, the apertures being adapted for receiving fasteners for mounting the bracket to the door frame.

4. The lock of claim 1, wherein a thickness of the bracket is configured to allow opening of the door when the lock body and the main body are removed from the door frame.

5. The lock of claim 1, wherein the opening adapted for receiving the bolt is in a forward projecting section of the bracket.

6. The lock of claim 1, wherein each of the main body and the bracket is symmetrical about a central axis defined by the cylinder, so that one of the pair of extensions and one of the pair of recesses are on each side of the cylinder.

7. The lock of claim 1, wherein the bracket is adapted to be mounted on a lower rail of the door frame.

8. The lock of claim 1, wherein the bracket is adapted to be mounted on an upper rail of the door frame.

9. The lock of claim 1, further comprising a pair of screws, the lock body having a pair of through apertures adapted for insertion of the screws, the main body having a pair of apertures matching the apertures of the lock body and adapted for receiving extremities of the screws.

10. The lock of claim 1, further comprising a cover for the lock body, the cover covering a top side, lateral sides, and a rear face of the lock body, a rear face of the cover being adapted to be placed in contact with edges of the panes when the lock is in a locked position on the door frame.

11. A lock, comprising:
a cylinder operatively connected to a bolt;
a main body having a bore adapted for receiving the cylinder so that the cylinder can be actuated from a front of the main body, the main body further having a pair of extensions projecting from a rear of the main body; and
a bracket adapted to be mounted to a frame, the bracket forming a pair of recesses configured for receiving the pair of extensions between the bracket and the frame, the bracket further having an opening adapted for receiving the bolt when the bolt is placed in a locking position by action of the cylinder.

12. A lockable refrigerator door system, comprising:
a door frame comprising four frame sections assembled to form a rectangular opening, the four frame sections comprising left and right vertical rails, an upper horizontal rail and a lower horizontal rail;
a double pane door, one pane having hinges mounted to the left vertical rail, an other pane having hinges mounted to the right vertical rail; and
the lock for double pane door of claim 1, wherein the bracket is mounted to one of the upper and lower horizontal rails, substantially at a junction between the panes of the double pane door.

13. A lockable refrigerator door system, comprising:
a door frame comprising:
an upper horizontal rail,
a lower horizontal rail, and
a plurality of vertical rails connecting the upper and lower horizontal rails so that a rectangular opening is formed between each pair of adjacent vertical rails;
a plurality of double pane doors, each double pane door being mounted in a corresponding rectangular opening so that one pane has hinges mounted to a vertical rail on a left side of the corresponding rectangular opening and an other pane has hinges mounted to a vertical rail on a right side of the corresponding rectangular opening; and
the lock for double pane door of claim 1 being mounted to one of the upper and lower horizontal rails, in each of the plurality of rectangular openings and substantially at a junction between panes of the double pane door mounted in that rectangular opening.
